(19) United States
(12) Patent Application Publication
(10) Pub. No.: US 2007/0074112 A1
(43) Pub. Date: Mar. 29, 2007

(54) Apparatus and method for consolidating reporting formulas

(75) Inventor: Joshua Maynard Knauer, Vancouver (CA)

Correspondence Address: COOLEY GODWARD KRONISH LLP, 3000 EL CAMINO REAL, 5 PALO ALTO SQUARE, PALO ALTO, CA, 94306, US

(73) Assignee: Business Objects, S.A. Levallois-Perret (FR)

(21) Appl. No.: 11/318,351

(22) Filed: Dec. 23, 2005

Related U.S. Application Data
(60) Provisional application No. 60/719,992, filed on Sep. 23, 2005.

(51) Int. Cl. G06F 17/00

(52) U.S. Cl. 715/538; 715/530

(57) ABSTRACT

A computer readable medium comprising executable instructions to consolidate formulas from a report; display the formulas; process edits to the formulas to identify valid and invalid edits; and present revised formulas.

### CROSS REFERENCE TO RELATED APPLICATIONS

This application claims the benefit of U.S. Provisional Application No. 60/719,992, entitled “Apparatus and Method for Consolidating Reporting Formulas,” filed on Sep. 23, 2005, the contents of which are hereby incorporated by reference in their entirety.

### BRIEF DESCRIPTION OF THE INVENTION

This invention relates generally to generating reports from stored digital data. More particularly, this invention relates to the consolidation and manipulation of formulas within reports.

### BACKGROUND OF THE INVENTION

There are a number of commercially available products to produce reports from stored data. For instance, Business Objects Americas of San Jose, Calif., sells a number of widely used report generation products, including Crystal Reports™, BusinessObjects OLAP Intelligence™, and BusinessObjects Enterprise™. As used herein, the term report refers to information automatically retrieved (i.e., in response to computer executable instructions) from a data source (e.g., a database, a data warehouse, and the like), where the information is structured in accordance with a report schema that specifies the form in which the information should be presented. A non-report is an electronic document that is constructed without the automatic retrieval (i.e., in response to computer executable instructions) of information from a data source. Examples of non-report electronic documents include typical business application documents, such as a word processor document, a spreadsheet document, a presentation document, and the like.

A report document is generally created by a specialized tool including executable instructions to access data and format it. A report document where the content does not include external data, either saved within the report or accessed live, is a template document for a report rather than a report document. Unlike, other non-report documents that may optionally import external data within a document, a report document by design is primarily a medium for accessing, formatting, and presenting external data.

A report design tool contains executable instructions specifically designed to facilitate working with external data sources. In addition to instructions regarding external data source connection drivers, these instructions may include advanced filtering of data, instructions for combining data from different external data sources, instructions for updating join structure and relationships in report data, and instructions including logic to support a more complex internal data model (that may include additional constraints, relationships, and metadata).

In contrast to a spreadsheet type application, a report generation tool generally is not limited to a table structure but can support a range of structures. A report design tool is designed primarily to support imported external data, whereas a spreadsheet application equally facilitates manually entered data and imported data. In both cases, a spreadsheet application applies a spatial logic that is based on the table cell layout within the spreadsheet in order to interpret data and perform calculations on the data. In contrast, a report design tool is not limited to logic that is based on the display of the data, but rather can interpret the data and perform calculations based on the original (or a redefined) data structure and meaning of the imported data. Spreadsheet applications work within a looping calculation model, whereas report generation tools may support a range of calculation models. Although there may be an overlap in the function of a spreadsheet document and a report document, the applications used to generate these documents contain instructions with different assumptions concerning the existence of an external data source and different logical approaches to interpreting and manipulating imported data.

Frequently, reports include one or more formulas. As used herein, a formula is any code associated with a report. Typically, the code specifies a function associated with a report. For example, formulas control such things as data refreshing, query filtering, and report formatting. Currently, these formulas are editable one at a time. If there are multiple formulas in a report, each formula needs to be opened, modified, and saved separately.

Consolidated editing exists in such products as Visual Basic™, sold by Microsoft Corporation, Redmond, Washington. These prior art approaches store code segments as text files along with data objects. Changes are propagated between the text files and the data objects during a separate compilation phase.

In view of the foregoing, it would be desirable to provide an improved technique for processing consolidated formulas.

### SUMMARY OF THE INVENTION

The invention includes a computer readable medium with executable instructions to consolidate formulas from a report; display the formulas; process edits to the formulas to identify valid and invalid edits; and present revised formulas.

The invention consolidates disparate formulas within a report object into a string, maps individual formulas to their respective representations within that string, and displays an appropriately formatted string in a single editable text view. Using the single editable text view, users can quickly see all of the errors within formulas, trace dependencies, and make additions, modifications and deletions using a single interface.

The invention departs from prior art consolidated editing tools in several ways. First, changes in the text editor of the invention result in immediate modifications to report objects. In other words, changes are not propagated between the text files and the data objects during a separate compilation phase, as is the case in the prior art. Second, the formula string of the invention is temporary (not persistent), unlike the text files used in prior art approaches. This allows for streamlined processing and reduced computer overhead.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates processing operations associated with an embodiment of the invention.

FIG. 3 illustrates a formula string in a single editable text view in accordance with an embodiment of the invention.

FIG. 4 illustrates editing of a formula string in accordance with an embodiment of the invention.

FIG. 5 illustrates valid and invalid changes to a formula string associated with an embodiment of the invention.

Like reference numerals refer to corresponding parts throughout the several views of the drawings.

### DETAILED DESCRIPTION OF THE INVENTION

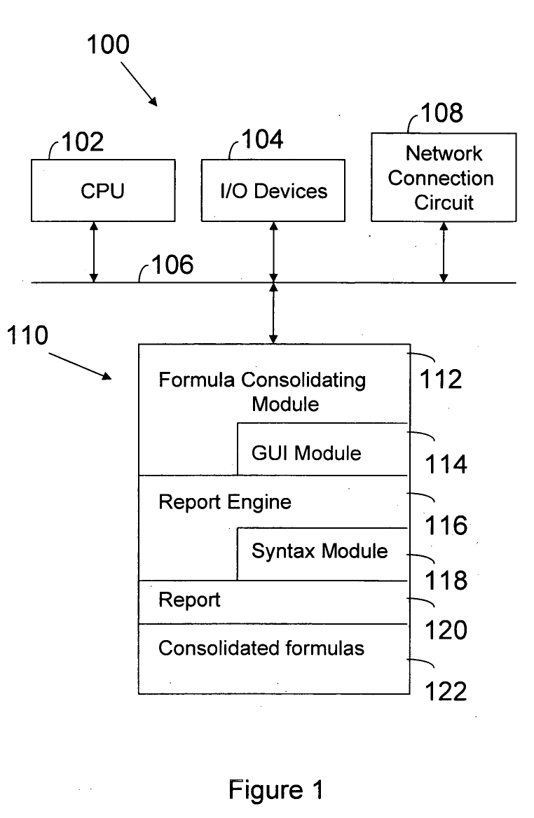

FIG. 1 illustrates a computer 100 configured in accordance with an embodiment of the invention. The computer 100 includes standard components, such as a central processing unit 102 and input/output devices 104 connected via a bus 106. The input/output devices 104 may include a keyboard, mouse, touch screen, monitor, printer, and the like. A network connection circuit 108 is also connected to the bus 106. The network connection circuit 108 provides an interface to any computer network (not shown).

A memory 110 is also connected to the bus 106. The memory 110 includes a formula consolidating module 110 configured in accordance with an embodiment of the invention. The formula consolidating module 110 includes executable instructions to implement the operations of the invention, as discussed below. In one embodiment, the formula consolidating module 110 includes a graphical user interface module 114 to present consolidated formulas, edits to consolidated formulas, and related information.

The memory 110 also stores a report engine 116. The report engine 116 includes a syntax module 114 with executable instructions to determine whether edits to a formula comply with pre-defined syntax requirements.

The formula consolidating module 112 operates on a report 120 to produce consolidated formulas 122. That is, the formula consolidating module 112 identifies each formula associated with a report and combines the formulas into a single entity, such as a text string. The formula consolidating module 112 may operate with a syntax module 118 of a report engine 116. The location of the code modules used to implement the invention is insignificant since any number of configurations may be used to implement the operations of the invention.

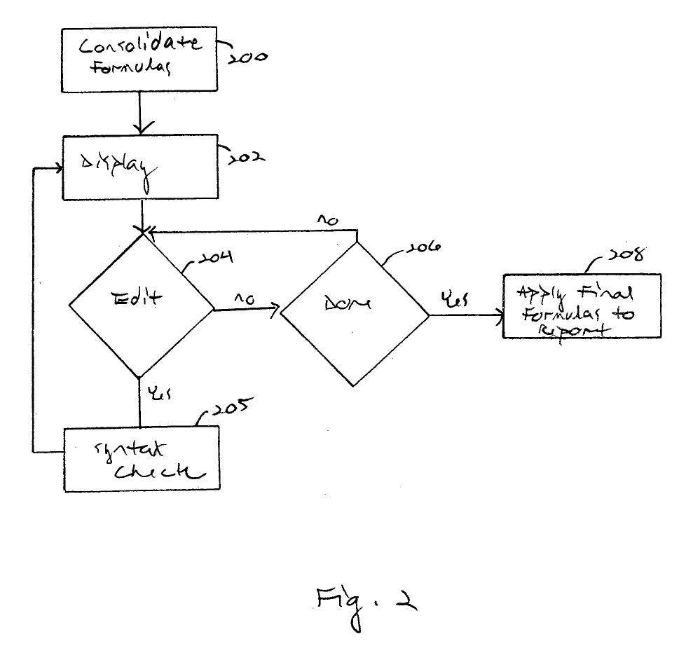

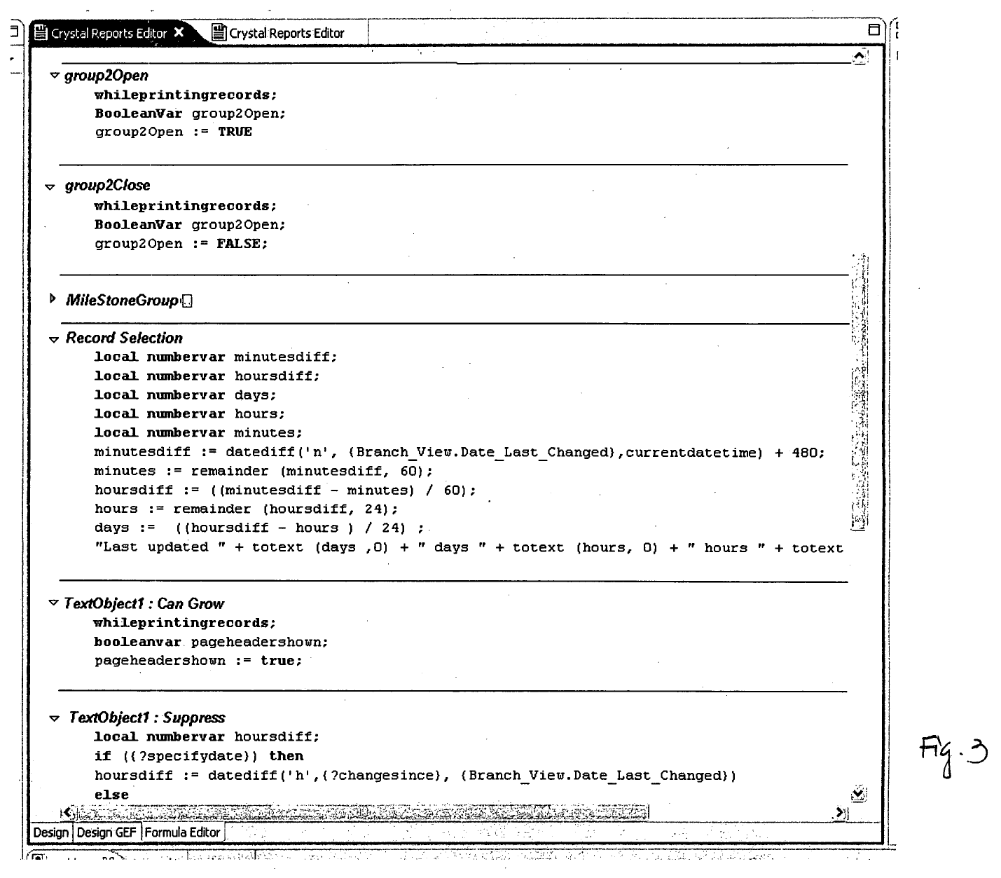

FIG. 2 illustrates processing operations associated with the formula consolidating module 110. Initially, formulas from a report are consolidated 200. The consolidated formulas are then displayed 202. For example, the consolidated formulas may be displayed as an editable text string. FIG. 3 illustrates formulas string in a single editable text view in accordance with an embodiment of the invention. The first formula string is entitled “group2Open” and specifies that a Boolean value “group2Open” is set to true during printing operations. The second formula string is entitled “group2Close” and specifies that the Boolean value “group2Open” is set to false during printing operations. Additional formula strings in the figure include “Record Selection”, “TextObject1:CanGrow”, and “TextObject1:Suppress”. These formulas specify various functions associated with a report.

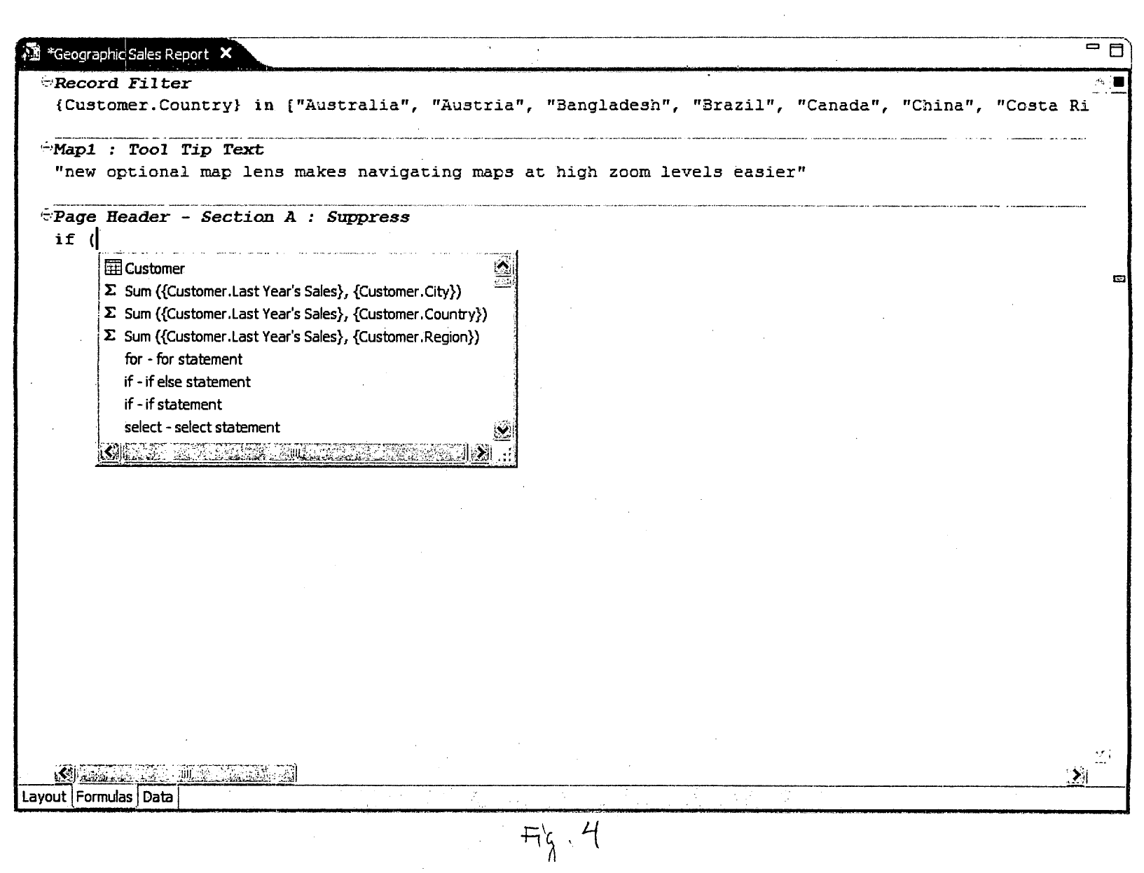

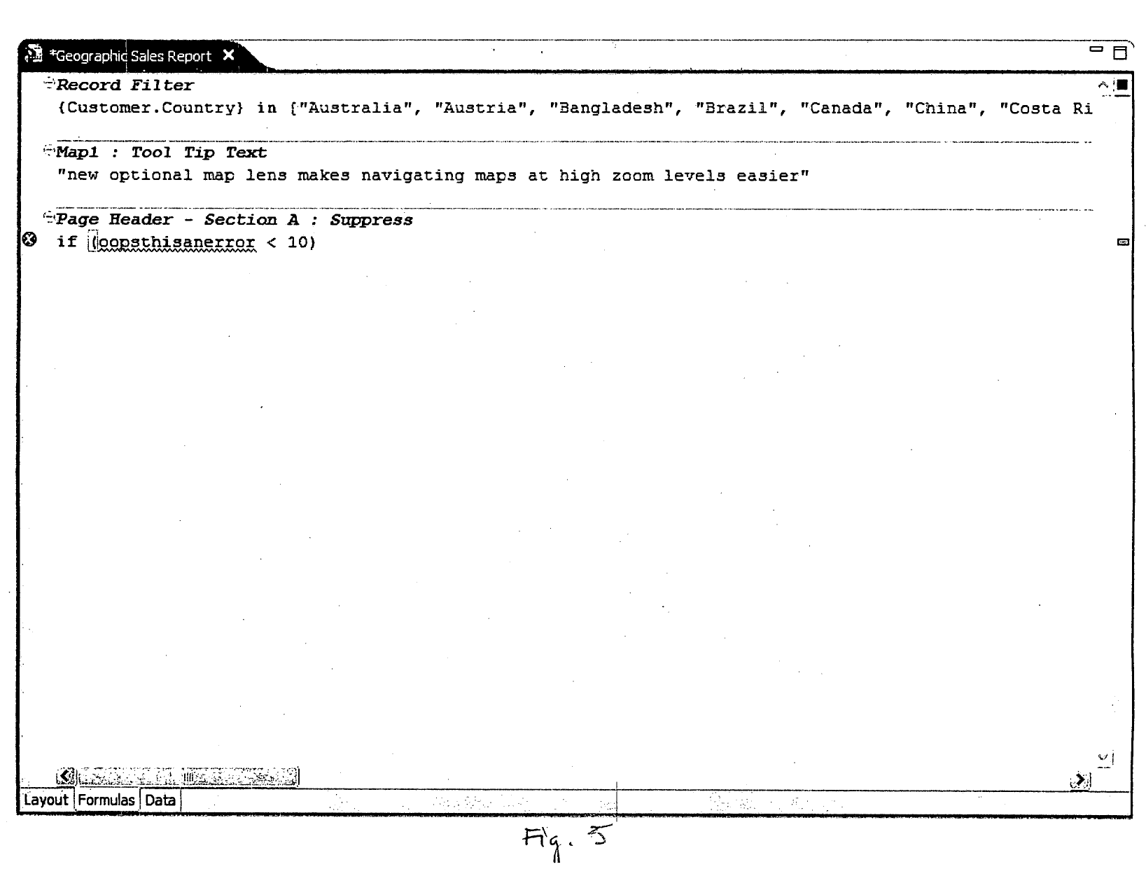

The formula may then be edited 204. The modification of a formula string may be based upon syntax edits in a command line or the selection of operations from a pull-down menu. FIG. 4 illustrates an interface that may be used for formula string modifications in accordance with an embodiment of the invention. In one embodiment of the invention, modifications to a formula string are saved into a cached version of a report. After an edit, the syntax module 118 checks the syntax 205. Preferably, the results of the syntax check are displayed 202. FIG. 5 illustrates valid and invalid changes to a formula string.

If the editing is done (block 206-Yes), the final formulas are applied to the report. The formula modifications may be committed to the report by saving the report. At this point, the consolidated formulas may be overwritten (i.e., they are a non-persistent object) to free up system resources.

The management of formula consolidation and on-the-fly updates form significant aspects of the invention. In one embodiment, this is enabled by leveraging a direct mapping between the formula fields in the report object to their representations within the consolidated string. Once changes to the string are detected and validated, they can be propagated back to the report object and appropriate updates are delivered to the user interface to allow the user to track the current state of the report's formulas.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium comprising executable instructions to:
consolidate formulas from a report;
display said formulas;
process edits to said formulas to identify valid and invalid edits; and
present revised formulas.

2. The computer readable medium of claim 1 wherein said executable instructions to display include executable instructions to display said formulas as a text string.

3. The computer readable medium of claim 2 wherein said executable instructions further comprise executable instructions to create a mapping between said formulas and said text string.

4. The computer readable medium of claim 1 wherein said executable instructions to present include executable instructions to visually display valid and invalid edits.

5. The computer readable medium of claim 1 further comprising executable instructions to apply said revised formulas to said report.

6. The computer readable medium of claim 5 wherein said executable instructions to apply include executable instructions to apply said revised formulas to said report by saving said report.

7. A computer readable medium, comprising:
a formula consolidation module to consolidate formulas from a report;
a graphical user interface module to display said formulas; and
a report engine with a syntax module to process edits to said formulas to identify valid and invalid edits, wherein the graphical user interface module presents revised formulas.

8. The computer readable medium of claim 7 wherein the graphical user interface module displays said formulas as a text string.

9. The computer readable medium of claim 8 further comprising executable instructions to create a mapping between said formulas and said text string.

10. The computer readable medium of claim 7 wherein the graphical user interface module visually displays valid and invalid edits.
